(19) United States
(12) Patent Application Publication
(10) Pub. No.: US 2026/0279799 A1
(43) Pub. Date: Sep. 17, 2026

(54) NEGATIVE ELECTRODE ACTIVE MATERIAL FOR FLUORIDE ION BATTERY, AND FLUORIDE ION BATTERY

(71) Applicants: TOYOTA JIDOSHA KABUSHIKI KAISHA, Aichi-ken (JP); INSTITUTE OF SCIENCE TOKYO, Tokyo (JP)

(72) Inventors: Yusuke SHIMO, Shizuoka-ken (JP); Naoki MATSUI, Meguro-ku (JP); Ryoji KANNO, Tokyo-to (JP)

(21) Appl. No.: 19/558,439

(22) Filed: Mar. 6, 2026

(30) Foreign Application Priority Data
Mar. 17, 2025 (JP) 2025-042963

(51) Int. Cl. H01M 4/58; H01M 4/02; H01M 4/136

(52) U.S. Cl. CPC H01M 4/582; H01M 4/136; H01M 2004/027

(57) ABSTRACT

The present disclosure provides a novel negative electrode active material for a fluoride ion battery, and a fluoride ion battery including such a negative electrode active material. A negative electrode active material for a fluoride ion battery of the present disclosure has an FeF₃-type defect perovskite structure and contains a metal fluoride which is titanium fluoride, vanadium fluoride, or a combination thereof. The fluoride ion battery of the present disclosure includes a negative electrode active material layer, and the negative electrode active material layer contains the negative electrode active material for the fluoride ion battery of the present disclosure.

### TECHNICAL FIELD

The present disclosure relates to a negative electrode active material for a fluoride ion battery, and a fluoride ion battery.

### BACKGROUND

As disclosed in PTLs 1 and 2, an electrode active material having a perovskite structure for a fluoride ion battery is known.

The electrode active materials having the perovskite structure disclosed in PTLs 1 and 2 have a high reaction potential during charging and discharging of the battery. Therefore, in PTLs 1 and 2, the electrode active materials are intended to be used particularly as positive electrode active materials.

### CITATION LIST

### Patent Literature

[PTL 1] Japanese Unexamined Patent Publication (Kokai) No. 2020-077509
[PTL 2] Japanese Unexamined Patent Publication (Kokai) No. 2018-106817

### SUMMARY

### Technical Problem

An object of the present disclosure is to provide a novel negative electrode active material for a fluoride ion battery, and a fluoride ion battery including such a negative electrode active material.

The present inventors have found that the above-described problem can be solved by the following method.

### <Aspect 1>

A negative electrode active material for a fluoride ion battery,
wherein the negative electrode active material has an FeF₃-type defect perovskite structure, and
wherein the negative electrode active material contains a metal fluoride which is titanium fluoride, vanadium fluoride, or a combination thereof.

### <Aspect 2>

The negative electrode active material for the fluoride ion battery according to Aspect 1, the metal fluoride is TiF₃, VF₃, or a combination thereof.

### <Aspect 3>

The negative electrode active material for the fluoride ion battery according to Aspect 2, the metal fluoride is TiF₃ or VF₃.

### <Aspect 4>

The negative electrode active material for the fluoride ion battery according to any one of Aspects 1 to 3,
wherein in an X-ray diffraction spectrum using a Cu-Kα ray as a radiation source, a first peak having a maximum peak intensity at a diffraction angle of 15° to 30° and a second peak having a maximum peak intensity at a diffraction angle of 40° to 50° are present, and
wherein a value obtained by dividing the peak intensity of the second peak by the peak intensity of the first peak is 0.30 or less.

### <Aspect 5>

A fluoride ion battery, including a negative electrode active material layer, wherein the negative electrode active material layer contains the negative electrode active material for the fluoride ion battery according to any one of Aspects 1 to 4.

### Advantageous Effects of Invention

According to the present disclosure, a novel negative electrode active material for a fluoride ion battery, and a fluoride ion battery including such a negative electrode active material can be provided.

### BRIEF DESCRIPTION OF DRAWINGS

FIG. 1 is a schematic cross-sectional view illustrating an example of a fluoride ion battery of the present disclosure.

FIG. 2 is an XRD spectrum of TiF₃ which is a negative electrode active material of Example 1.

FIG. 3 is an XRD spectrum of VF₃ which is a negative electrode active material of Example 2.

FIG. 4 is an XRD spectrum of TiF₄ which is a negative electrode active material of Comparative Example 1.

FIG. 5 is an XRD spectrum of TiFₓ which is a negative electrode active material of Comparative Example 2.

FIG. 6 is an XRD spectrum of ScF₃ which is a negative electrode active material of Comparative Example 3.

FIG. 7 is a charge-discharge curve of a battery of Example 1.

FIG. 8 is a charge-discharge curve of a battery of Example 2.

FIG. 9 is a charge-discharge curve of a battery of Comparative Example 1.

FIG. 10 is a charge-discharge curve of a battery of Comparative Example 2.

FIG. 11 is a charge-discharge curve of a battery of Comparative Example 3.

### DESCRIPTION OF EMBODIMENTS

Hereinafter, embodiments of the present disclosure will be described in detail. However, it should be noted that the present disclosure is not limited to the following embodiments, and can be variously modified within the scope thereof.

### <<Negative Electrode Active Material for Fluoride Ion Battery>>

A negative electrode active material for a fluoride ion battery of the present disclosure has an FeF₃-type defect perovskite structure and contains a metal fluoride which is titanium fluoride, vanadium fluoride, or a combination thereof.

The present inventors have unexpectedly found that the above-described metal fluoride functions as the negative electrode active material for the fluoride ion battery.

The reason for this is not intended to be bound by any theory, but is presumed to be as follows. Firstly, it is believed that the above-described metal fluoride has an FeF₃-type defect perovskite structure including a smaller number of positive ions and a larger number of voids than those in a simple perovskite structure, and thus fluoride ions as carrier ions are easily inserted into and desorbed from the metal fluoride.

Secondly, it is believed that the metal fluoride contains titanium, vanadium, or a combination thereof, which is a transition metal having a relatively low oxidation-reduction potential, and thus a charge-discharge reaction occurs at a relatively low potential.

It should be noted that the negative electrode active material for the fluoride ion battery is usually defluorinated during charging and fluorinated during discharging.

Hereinafter, each element constituting the negative electrode active material for the fluoride ion battery of the present disclosure will be described.

### <Crystal Structure>

The negative electrode active material for the fluoride ion battery of the present disclosure has the FeF₃-type defect perovskite structure. Accordingly, fluoride ions as carrier ions are easily inserted into and extracted from the metal fluoride.

### <Metal Fluoride>

The metal fluoride contained in the negative electrode active material for the fluoride ion battery of the present disclosure is titanium fluoride, vanadium fluoride, or a combination thereof. Accordingly, a charge-discharge reaction occurs at a relatively low potential.

The metal fluoride may be TiF₃ (titanium trifluoride), VF₃ (vanadium trifluoride), or a combination thereof. Specifically, the titanium fluoride may be TiF₃, and the vanadium fluoride may be VF₃. Particularly, the metal fluoride may be TiF₃ or VF₃.

The metal fluoride may be a commercially available product or may be prepared by a usual method.

In the negative electrode active material for the fluoride ion battery of the present disclosure, in an X-ray diffraction spectrum using Cu-Kα radiation as a radiation source, a first peak having a maximum peak intensity at a diffraction angle of 15° to 30° and a second peak having a maximum peak intensity at a diffraction angle of 40° to 50° may be present, and a value obtained by dividing the peak intensity of the second peak by the peak intensity of the first peak may be 0.30 or less. In this way, it is possible to confirm that the metal fluoride has the FeF₃-type defect perovskite structure.

The value obtained by dividing the peak intensity of the second peak by the peak intensity of the first peak may be 0.01 or more, 0.05 or more, 0.10 or more, 0.15 or more, 0.20 or more, or 0.25 or more, and may be 0.30 or less, 0.25 or less, or 0.20 or less.

The XRD measurement can be performed using an X-ray diffraction (XRD) apparatus (Miniflex manufactured by Rigaku Corporation) with a Cu-Kα radiation source under an argon atmosphere, under conditions of a measurement range of from 10° to 80°, a scan speed of 2°/min, and a measurement interval of 0.02°.

The negative electrode active material for the fluoride ion battery of the present disclosure may or may not contain a negative electrode active material other than the metal fluoride. The negative electrode active material other than the metal fluoride is not particularly limited.

### <Negative Electrode Mixture>

A negative electrode mixture contains the negative electrode active material for the fluoride ion battery of the present disclosure, and may optionally contain a solid electrolyte, a conductive additive, a binder, and the like.

In the present disclosure, the “negative electrode mixture” refers to a composition that can constitute a negative electrode active material layer as is, or by further containing other components.

### <Negative Electrode Active Material>

For the negative electrode active material for the fluoride ion battery of the present disclosure, the above description can be referred to.

The content of the negative electrode active material in the negative electrode mixture is not particularly limited, and can be appropriately set in consideration of a desired capacity of the battery and the like. The content of the negative electrode active material in the negative electrode mixture may be, for example, 1% by mass or more, 5% by mass or more, 10% by mass or more, 15% by mass or more, 20% by mass or more, 25% by mass or more, or 30% by mass or more, and may be 100% by mass or less, 80% by mass or less, 60% by mass or less, 50% by mass or less, 45% by mass or less, 40% by mass or less, 35% by mass or less, or 30% by mass or less. The content may be 10% by mass to 50% by mass, 15% by mass to 45% by mass, or 20% by mass to 40% by mass.

The shape, size, and the like of the negative electrode active material are not particularly limited, as long as the negative electrode active material can function as the negative electrode active material of the fluoride ion battery.

### <Solid Electrolyte>

The solid electrolyte is not particularly limited, as long as it has fluoride ion conductivity.

Examples of the solid electrolyte include fluorides of lanthanoid elements such as La and Ce, fluorides of alkali metal elements such as Li, Na, K, Rb, and Cs, and fluorides of alkaline earth elements such as Ca, Sr, and Ba. The solid electrolyte may also be a fluoride containing a combination of two or more of elements selected from the lanthanoid elements, the alkali metal elements, and the alkaline earth metal elements.

Specific examples of the solid electrolyte include La₍₁₋ₓ₎BaₓF₍₃₋ₓ₎ (0≤x≤1), Pb₍₁₋ₓ₎SnₓF₂ (0≤x≤1), Ca₍₁₋ₓ₎BaₓF₂ (0≤x≤1), and Ce₍₁₋ₓ₎BaₓF₍₃₋ₓ₎ (0≤x≤1). Each x above may be greater than 0, 0.1 or more, 0.2 or more, 0.3 or more, 0.4 or more, or 0.5 or more, and may be less than 1, 0.9 or less, 0.8 or less, 0.7 or less, 0.6 or less, or 0.5 or less. The solid electrolyte may be, for example, calcium barium fluoride represented by the composition formula of Ca_{0.5}Ba_{0.5}F₂.

The content of the solid electrolyte in the negative electrode mixture is not particularly limited, and can be appropriately set in consideration of desired ion conductivity and the like. The content of the solid electrolyte in the negative electrode mixture may be, for example, 1% by mass or more, 10% by mass or more, 30% by mass or more, 50% by mass or more, or 60% by mass or more, and may be 99% by mass or less, 90% by mass or less, 80% by mass or less, 70% by mass or less, or 60% by mass or less.

The shape, size, and the like of the solid electrolyte are not particularly limited, as long as the solid electrolyte can function as the solid electrolyte of the fluoride ion battery.

### <Conductive Additive>

The conductive additive is not particularly limited, as long as it has electron conductivity. The conductive additive may be, for example, a carbon material, a metal simple substance or a metal compound, or a combination thereof.

The carbon material may be, for example, carbon black such as acetylene black, Ketjen black, or furnace black, graphite powder, a fibrous carbon material such as vapor grown carbon fiber (VGCF), or a combination thereof.

The content of the conductive additive in the negative electrode mixture is not particularly limited, and can be appropriately set in consideration of desired electron conductivity and the like.

### <Binder>

The binder is not particularly limited, and may be, for example, a fluorine-based binder such as polyvinylidene fluoride (PVDF) or polytetrafluoroethylene (PTFE), a rubber-based binder such as styrene-butadiene rubber (SBR), or a combination thereof.

The content of the binder in the negative electrode mixture is not particularly limited, and can be appropriately set in consideration of desired binding properties and the like.

### <Other Components>

The negative electrode mixture may or may not contain a component other than the above-described components. The types, contents, and the like of the other components can be set as appropriate.

### <<Fluoride Ion Battery>>

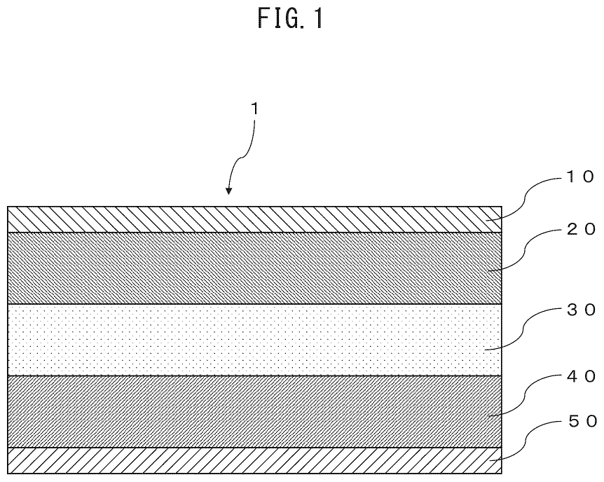

The fluoride ion battery of the present disclosure includes a negative electrode active material layer, and the negative electrode active material layer contains the negative electrode active material for the fluoride ion battery of the present disclosure. As illustrated in FIG. 1, a fluoride ion battery 1 of the present disclosure may include a negative electrode current collector layer 10, a negative electrode active material layer 20 containing the negative electrode active material for the fluoride ion battery of the present disclosure, an electrolyte layer 30, a positive electrode active material layer 40, and a positive electrode current collector layer 50 in this order.

The fluoride ion battery of the present disclosure may be a liquid-based battery or a solid-state battery, and in particular may be a solid-state battery. In the present disclosure, the “solid-state battery” means a battery including at least a solid electrolyte as the electrolyte. Thus, the solid-state battery may include a combination of a solid electrolyte and a liquid electrolyte as the electrolyte. The solid-state battery may be an all-solid-state battery, i.e., a battery using only a solid electrolyte as the electrolyte.

The fluoride ion battery may be a primary battery or a secondary battery, and in particular may be a secondary battery.

The fluoride ion battery may have, for example, a coin shape, a laminate shape (pouch shape), a cylindrical shape, or a square shape.

The fluoride ion battery of the present disclosure can be suitably used in at least one vehicle selected from a hybrid vehicle (HEV), a plug-in hybrid vehicle (PHEV), and an electric vehicle (BEV), for example.

Hereinafter, each element that can constitute the fluoride ion battery of the present disclosure will be described. In particular, a case wherein the battery of the present disclosure is the all-solid-state fluoride ion battery will be described as an example.

### <Negative Electrode Current Collector Layer>

Examples of the material of a negative electrode current collector layer include stainless steel (SUS), copper, nickel, iron, titanium, platinum, and carbon.

### <Negative Electrode Active Material Layer>

The negative electrode active material layer contains the negative electrode active material for the fluoride ion battery of the present disclosure. For the negative electrode active material for the fluoride ion battery of the present disclosure, the above description can be referred to.

The negative electrode active material layer may be obtained by forming, into a sheet shape, the negative electrode mixture itself containing the negative electrode active material for the fluoride ion battery of the present disclosure. For the negative electrode mixture, the above description can be referred to.

### <Electrolyte Layer>

The electrolyte layer contains a solid electrolyte and may optionally contain a binder.

### (Solid Electrolyte and Binder)

For the solid electrolyte and the binder, the above description can be referred to.

### <Positive Electrode Active Material Layer>

The positive electrode active material layer contains a positive electrode active material and may optionally contain a solid electrolyte, a conductive additive, and a binder.

### (Positive Electrode Active Material)

The positive electrode active material is normally fluorinated during charging and defluorinated during discharging. Examples of the positive electrode active material include a metal simple substance, an alloy, a metal oxide, and fluorides thereof. Examples of the metal element contained in the positive electrode active material include Cu, Ag, Ni, Co, Pb, Mn, Au, Pt, Rh, V, Os, Ru, Fe, Cr, Bi, Nb, Sb, Ti, Sn, and Zn.

### (Solid Electrolyte, Conductive Additive, and Binder)

For the solid electrolyte, the conductive additive, and the binder, the above description can be referred to.

### <Positive Electrode Current Collector Layer>

Examples of the material of a positive electrode current collector layer include lead, stainless steel (SUS), aluminum, nickel, iron, titanium, platinum, and carbon.

The shape of each of the above-described layers is not particularly limited, and may be, for example, a sheet shape having a substantially flat surface.

The thickness of each of the above-described layers is not particularly limited, and can be appropriately adjusted in accordance with the configuration of the battery.

The fluoride ion battery of the present disclosure may further have a configuration other than the above-described configuration.

### EXAMPLES

### Example 1

### <Production of Negative Electrode Active Material Layer>

Titanium trifluoride (TiF₃) (manufactured by Sigma-Aldrich Co. LLC.) as a negative electrode active material, calcium barium fluoride (Ca_{0.5}Ba_{0.5}F₂) as a solid electrolyte, and vapor-grown carbon fibers (VGCF) (manufactured by Showa Denko K.K.) as a conductive additive were weighed so that the mass ratio thereof was 30:60:10. These were mixed at 200 rpm for 10 hours by ball milling to prepare a negative electrode mixture containing TiF₃. The obtained negative electrode mixture was subjected to powder compacting to produce a negative electrode active material layer.

Ca_{0.5}Ba_{0.5}F₂ was prepared by mixing calcium fluoride (CaF₂) (manufactured by Kojundo Chemical Laboratory Co., Ltd.) and barium fluoride (BaF₂) (manufactured by Kojundo Chemical Laboratory Co., Ltd.) at 600 rpm for 20 hours by ball milling.

### <Production of Solid Electrolyte Layer>

Ca_{0.5}Ba_{0.5}F₂ as a solid electrolyte was subjected to powder compacting to obtain a solid electrolyte layer.

### <Production of Positive Electrode Active Material Layer>

Lead fluoride (PbF₂) (manufactured by Kojundo Chemical Laboratory Co., Ltd.) and acetylene black (manufactured by Denka Company Limited) were weighed so that the mass ratio thereof was 95:5. These were mixed at 600 rpm for 3 hours by ball milling to prepare a positive electrode mixture. The obtained positive electrode mixture was subjected to powder compacting to produce a positive electrode active material layer.

### <Production of Battery>

A platinum foil as a negative electrode current collector layer, a negative electrode active material layer, a solid electrolyte layer, a positive active material layer, and a lead foil as a positive electrode current collector layer were layered in this order to produce an all-solid-state fluoride ion battery.

### Example 2

An all-solid-state fluoride ion battery of Example 2 was obtained in the same manner as in Example 1 except that vanadium trifluoride (VF₃) (manufactured by Kojundo Chemical Laboratory Co., Ltd.) was used as the negative electrode active material, and the all-solid-state fluoride ion battery was evaluated.

### Comparative Example 1

An all-solid-state fluoride ion battery of Comparative Example 1 was obtained in the same manner as in Example 1 except that titanium tetrafluoride (TiF₄) (manufactured by Sigma-Aldrich Co. LLC.) was used as the negative electrode active material, and the all-solid-state fluoride ion battery was evaluated.

### Comparative Example 2

An all-solid-state fluoride ion battery of Comparative Example 2 was obtained in the same manner as in Example 1 except that titanium fluoride (TiFₓ) was used as the negative electrode active material. Titanium fluoride (TiFₓ) was prepared by electrochemically fluorinating metallic titanium (Ti) (manufactured by Sigma-Aldrich Co. LLC.).

### Comparative Example 3

An all-solid-state fluoride ion battery of Comparative Example 3 was obtained in the same manner as in Example 1 except that scandium fluoride (ScF₃) (manufactured by Kojundo Chemical Laboratory Co., Ltd.) was used as the negative electrode active material, and the rotation speed of the ball mill at the time of preparing the negative electrode mixture was set to 100 rpm.

The defect structure of the negative electrode active material of each of the examples, and the presence or absence of the perovskite structure are shown in Table 1.

### <<XRD Measurement>>

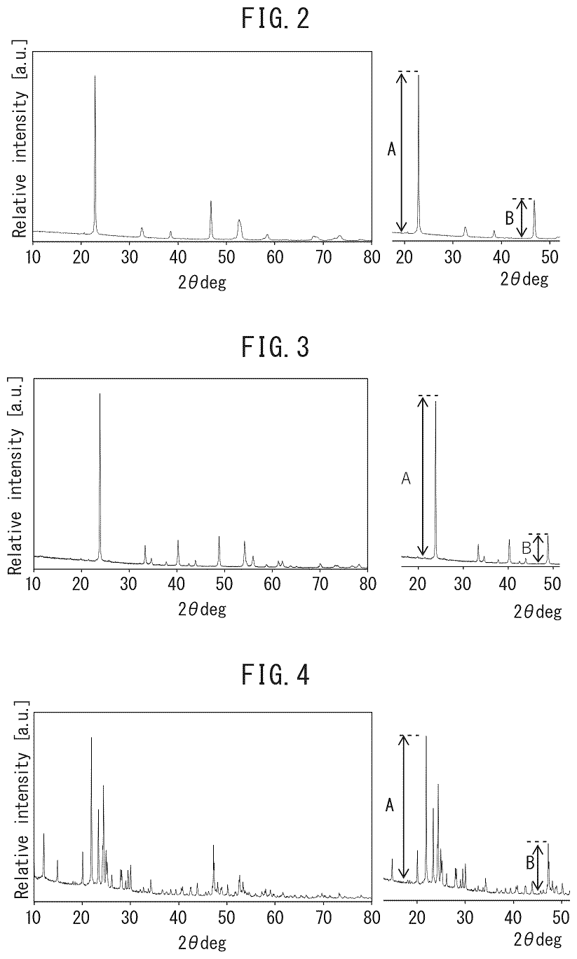

The XRD measurement was performed on the negative electrode active material of each of the examples. The XRD measurement was performed using an X-ray diffraction (XRD) apparatus (Miniflex manufactured by Rigaku Corporation) with a Cu-Kα radiation source under an argon atmosphere, under conditions of a measurement range of from 10° to 80°, a scan speed of 2°/min, and a measurement interval of 0.02°. The obtained XRD spectra are shown in FIGS. 2 to 6 in the order of Examples 1 and 2 and Comparative Examples 1 to 3. In FIGS. 2 to 4 and 6, enlarged views at diffraction angles of around 20° to 50° are also shown, and in these enlarged views, the peak intensity of the first peak and the peak intensity of the second peak are indicated as “A” and “B”, respectively, for convenience. The value (B/A) obtained by dividing the peak intensity of the second peak by the peak intensity of the first peak in each of the examples is shown in Table 1.

### <<Charge and Discharge Test>>

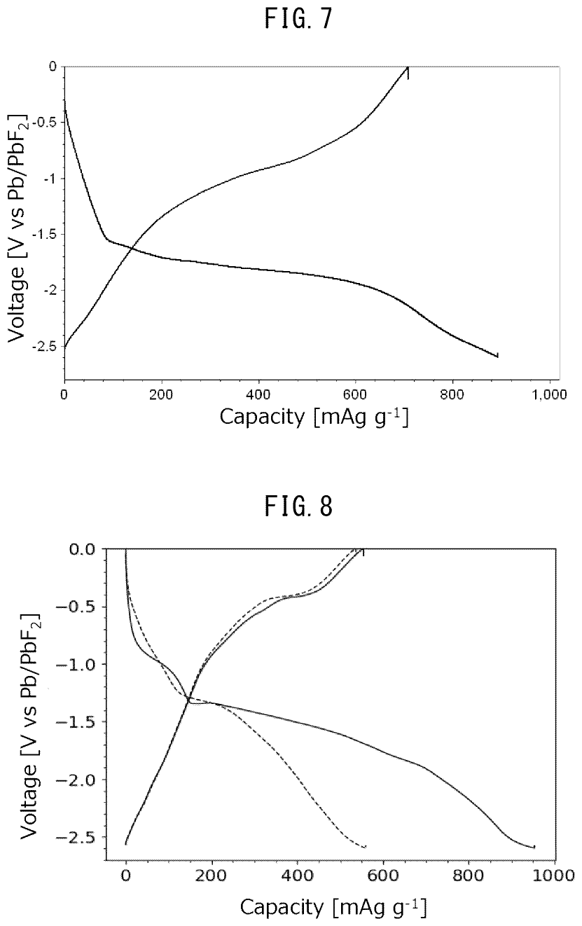

Charge and discharge tests were performed at 50 μA and 200° C. in the voltage range of from 0 V to −2.6 V (vs Pb/PbF₂). Specifically, for the batteries of Examples 1 and 2 and Comparative Examples 1 and 3, charge-discharge curves were obtained, based on the initial defluorination (charging) and fluorination (discharging), starting from defluorination, i.e., charging from the open circuit voltage to −2.6 V. For the battery of Comparative Example 2, the charge-discharge curve was obtained, based on the initial fluorination (discharging) and defluorination (charging), starting from fluorination, i.e., discharging from the open circuit voltage to 0 V. The charge-discharge curves of the batteries of Examples 1 and 2 and Comparative Examples 1 to 3 are shown in FIGS. 7 to 11, respectively, in this order, and the defluorination capacity and fluorination capacity are shown in Table 1.

TABLE 1
Table 1

| | Negative Electrode Active Material | | | Charge and Discharge | |
|---|---|---|---|---|---|
| | | | Peak Intensity of | Test Results | |
| | | | Second Peak/ | Defluorination | Fluorination |
| | Composition | Perovskite | Peak Intensity of | Capacity | Capacity |
| | Formula | Structure | First Peak | [mAh/g] | [mAh/g] |
| Example 1 | TiF₃ | Present | 0.25 | 893.5 | 708.1 |
| | | (FeF₃-type) | | | |
| Example 2 | VF₃ | Present | 0.19 | 953.3 | 554.7 |
| | | (FeF₃-type) | | | |
| Comparative | TiF₄ | None | 0.35 | 261.1 | 62.3 |
| Example 1 | | | | | |
| Comparative | TiFₓ | None | — | 89.6 | 46.0 |
| Example 2 | | | | | |
| Comparative | ScF₃ | Present | 0.36 | 614.3 | 306.0 |
| Example 3 | | (ReO₃-type) | | | |

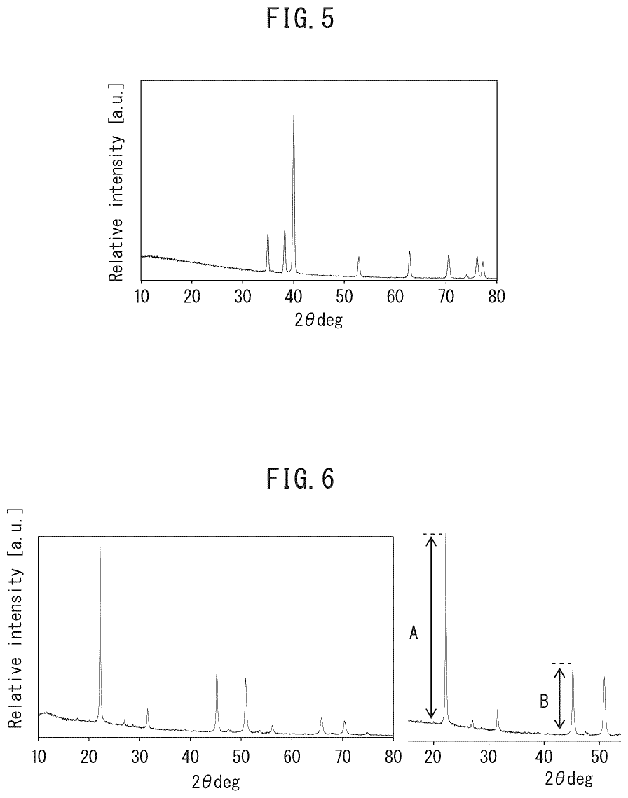

As shown in Table 1 and FIGS. 2 and 3, in TiF₃ and VF₃ of Examples 1 and 2, the value obtained by dividing the peak intensity of the second peak by the peak intensity of the first peak was 0.3 or less. In contrast, as shown in Table 1 and FIGS. 4 and 6, in TiF₄ and ScF₃ of Comparative Examples 1 and 3, the value obtained by dividing the peak intensity of the second peak by the peak intensity of the first peak was greater than 0.3. It should be noted that the first peak and the second peak are peaks derived from the perovskite structure, but in TiF₄ used in Comparative Example 1, it appears that a peak derived from another structure is observed in a range of the diffraction angle including these peaks. In addition, as shown in FIG. 5, no peak corresponding to the first peak was observed in TiFₓ used in Comparative Example 2. Based on the above, it was confirmed that only TiF₃ and VF₃ had the FeF₃-type defect perovskite structure.

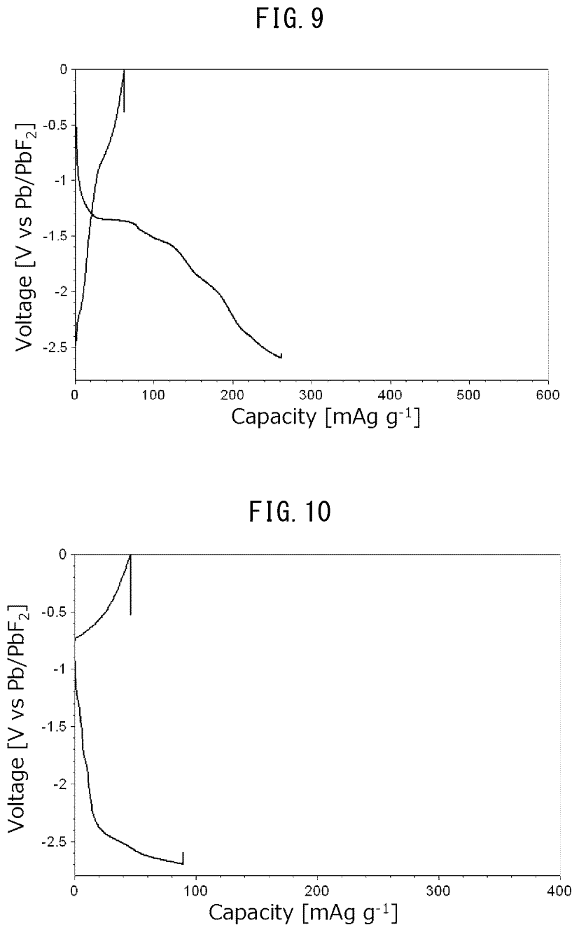

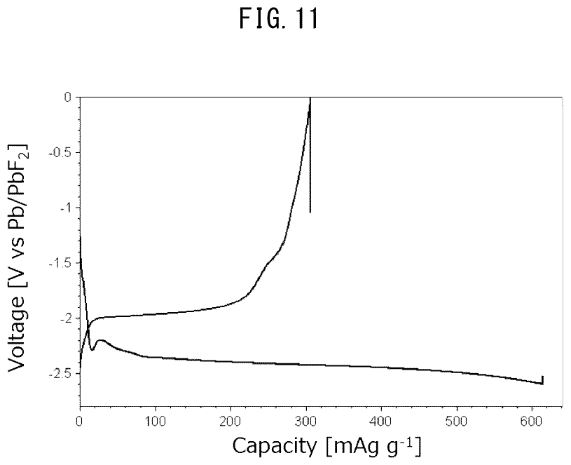

As shown in Table 1 and FIGS. 7 and 8, it was confirmed that, in the batteries of Examples, both the defluorination capacity and the fluorination capacity were large and the charge-discharge reaction proceeded reversibly. In contrast, as shown in Table 1 and FIG. 9, in the battery of Comparative Example 1, both the defluorination capacity and the fluorination capacity were smaller than those of the batteries of Examples, and the fluorination capacity was particularly small. As shown in Table 1 and FIG. 10, in the battery of Comparative Example 2, both the defluorination capacity and the fluorination capacity were the smallest. The standard oxidation-reduction potential of Sc³⁺ constituting ScF₃ used in Comparative Example 3 is lower than the standard oxidation-reduction potential of Ti³⁺ and V³⁺. Nevertheless, as shown in Table 1 and FIG. 11, in the battery of Comparative Example 3, both the defluorination capacity and the fluorination capacity were smaller than those of the batteries of Examples, and the fluorination capacity was particularly small. This suggests that the increase in the capacity of the battery is caused not only by the low oxidation-reduction potential of the negative electrode active material, but also by the crystal structure.

### REFERENCE SIGNS LIST

1 Fluoride ion battery
10 Negative electrode current collector layer
20 Negative electrode active material layer
30 Electrolyte layer
40 Positive electrode active material layer
50 Positive electrode current collector layer

1. A negative electrode active material for a fluoride ion battery,
wherein the negative electrode active material has an FeF₃-type defect perovskite structure, and
wherein the negative electrode active material contains a metal fluoride which is titanium fluoride, vanadium fluoride, or a combination thereof.

2. The negative electrode active material for the fluoride ion battery according to claim 1, the metal fluoride is TiF₃, VF₃, or a combination thereof.

3. The negative electrode active material for the fluoride ion battery according to claim 2, the metal fluoride is TiF₃ or VF₃.

4. The negative electrode active material for the fluoride ion battery according to claim 1,
wherein in an X-ray diffraction spectrum using a Cu-Kα ray as a radiation source, a first peak having a maximum peak intensity at a diffraction angle of 15° to 30° and a second peak having a maximum peak intensity at a diffraction angle of 40° to 50° are present, and
wherein a value obtained by dividing the peak intensity of the second peak by the peak intensity of the first peak is 0.30 or less.

5. A fluoride ion battery, including a negative electrode active material layer, wherein
the negative electrode active material layer contains the negative electrode active material for the fluoride ion battery according to claim 1.
